(19) United States
(12) Patent Application Publication
(10) Pub. No.: US 2012/0208561 A1
(43) Pub. Date: Aug. 16, 2012

(54) LOCATION METHOD, APPARATUS AND SYSTEM

(76) Inventors: Dajun Zhang, Beijing (CN); Jiayi Fang, Beijing (CN); Haiyang Quan, Beijing (CN)

(21) Appl. No.: 13/502,519

(22) PCT Filed: Nov. 4, 2010
(86) PCT No.: PCT/CN10/78415

§ 371 Date: Apr. 17, 2012

(30) Foreign Application Priority Data
Nov. 5, 2009 (CN) 200910237241.7

(51) Int. Cl. H04W 64/00

(52) U.S. Cl. 455/456.2

(57) ABSTRACT

The present invention discloses a locating method, apparatus and system, and the method comprises the following steps: a Mobility Management Entity (MME) receives a locating service request, selects an Evolved Service Mobile Location Center (E-SMLC), and transmits the locating service request including a locating identifier to the selected E-SMLC; the MME receives a User Equipment (UE) specific message including the locating identifier transmitted by the E-SMLC, and communicates the locating information with the E-SMLC using the locating identifier. The embodiments of the present invention can ensure the correct delivery of the locating information, and further improve the correctness of the locating technology.

This application claims the priority of China Patent Application Ser. NO. 200910237241.7, entitled LOCATING METHOD, APPARATUS AND SYSTEM, submitted on Nov. 5, 2009, the contents of which are hereby incorporated in their entirety.

### TECHNICAL FIELD

The present disclosure relates generally to communication technology, and, more particularly, to a locating method, apparatus and system.

### BACKGROUND

The mobile locating service is the service based on the locating of UE (User Equipment), including the service of emergency assistance and so on. At present, the mobile locating includes Control-Plane Locating and Secure User-Plane Locating; the Control-Plane Locating refers to the signaling link in whose processing of locating the E-UTRAN (Evolved Universal Terrestrial Radio Access Network) is needed, MME (Mobility Management Entity) transmitting locating request to E-SMLC (Enhanced Serving Mobile Locating Center), so as to trigger locating process. Once completed locating operation, E-SMLC returns the result of locating to MME, E-SMLC, MME, eNodeB and UE may involve in the process of locating.

As is shown in FIG. 1, the schematic diagram of locating framework that relates to E-UTRAN in present technology, including E-SMLC, MME, eNodeB and UE, the E-SMLC is used for transferring the locating requirement requested by client into corresponding E-UTRAN measuring parameters, and selecting measuring method, estimating of the final result and accuracy on returned locating; the MME providing with mobility management to LCS (Location Services), including reporting the movement of UE to E-SMLC/GMLC (Gateway Mobile Location Center); the eNodeB providing with the measuring results that relates to locating service to E-SMLC, and transmitting supporting information which is needed for locating service; the UE providing with the measuring results that relates to locating service to E-SMLC.

In addition, the relationship between the interfaces of LPP (LTE Positioning Protocol) stack and the relationship between the interfaces of LPPa (LTE Positioning Protocol Annex) stack is as shown in FIG. 2 and FIG. 3, separately. After being received locating service request, MME transmitting the locating service request to a selected E-SMLC. As a locating center, the E-SMLC is responsible for processing the locating needs from MME, selecting a appropriate locating method according to corresponding property such as QoS (Quality of Service). At present, the supportable locating method including: E-CID (Enhanced Cell-ID), OTDOA (Observed Time Difference Of Arrival), A-GNSS (Advanced Global Navigation Satellite System) and so on. For the locating method calculated by network side, transmitting LPPa messages between E-SMLC and eNodeB is needed to complete the locating requirement of client; for the locating method that supported by client, transmitting LPP messages between E-SMLC and UE is needed to complete the locating requirement of client.

In the implementing procedure of the invention, the applicant found at least following problems in present technique:

There is a lack of appropriate method for addressing in present locating scheme, the correct delivery of the locating information could not be ensured, which affects the improvement of locating technology.

### CONTENTS OF THE INVENTION

The embodiments of the invention provide with a locating method, device and system, for ensuring the correct delivery of the locating information, and further improve the correctness of the locating technology.

The embodiments of the invention provide with a locating method, comprising following steps:

Mobility Management Entity (MME) receiving locating service request, selecting Enhanced Serving Mobile Location Center (E-SMLC), transmitting the locating service request which includes locating identifier to the selected E-SMLC;

The said MME receiving the user equipment (UE) specific message that includes locating identifier, which is transmitted from the said E-SMLC, communicating locating information with the said E-SMLC by using the said locating identifier.

The embodiments of the invention also provide with a MME, comprising:

Allocating Module for receiving locating service request, selecting E-SMLC, and allocating locating identifier for the said selected E-SMLC;

Transmitting Module for transmitting the locating service request which includes the locating identifier allocated by the said Allocating Module to the said E-SMLC, so the said E-SMLC establishing locating context information according to the said locating identifier and allocating relationship identifier for the said locating context information;

Receiving Module for receiving user equipment (UE) specific message that includes relationship identifier from the said E-SMLC, communicating locating information with the said E-SMLC by using the said relationship identifier.

The embodiments of the invention also provide with a MME, comprising:

Allocating Module for receiving locating service request, selecting E-SMLC;

Transmitting Module for transmitting the locating service request which includes locating identifier to the E-SMLC that selected by the said Allocating Module;

Receiving Module for receiving UE specific message that includes relationship identifier, which is transmitted from the said E-SMLC, communicating locating information with the said E-SMLC by using the said relationship identifier.

The embodiments of the invention also provide with locating system, comprising:

MME for receiving locating service request, selecting E-SMLC, and allocating locating identifier for the said selected E-SMLC, transmitting the locating service request that includes the said locating identifier to the said E-SMLC, receiving the UE specific message that includes relationship identifier from the said E-SMLC, communicating locating information with the said E-SMLC by using the said relationship identifier;

E-SMLC for receiving the locating service request from the said MME, saving the locating identifier which in the said locating service request to the said locating context information, and allocating relationship identifier for the said locating context information, transmitting the UE specific messages that include the said locating identifier and/or the said relationship identifier to the said MME.

The embodiments of the invention also provide with locating system, comprising:

MME for receiving locating service request, selecting E-SMLC, transmitting the locating service request that includes locating identifier to the said selected E-SMLC, receiving the UE specific message that includes relationship identifier from the said E-SMLC, communicating locating information with the said E-SMLC by using the said relationship identifier;

E-SMLC for receiving the locating service request from the said MME, saving the locating identifier which in the said locating service request to locating context information, transmitting the UE specific messages that include the said locating identifier to the said MME.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

### BRIEF DESCRIPTION OF THE DRAWINGS

FIG. 1 illustrates the framework of locating which relates to E-UTRAN in present technology;

FIG. 2 illustrates the relationship between the interfaces of LPP stack in mobile locating technology;

FIG. 3 illustrates the relationship between the interfaces of LPPa stack in mobile locating technology;

FIG. 4 is a schematic flow of a locating method in the embodiment 1 of the invention;

FIG. 5 is a schematic flow of a locating method in the embodiment 2 of the invention;

FIG. 6 is a schematic flow of a locating method in the embodiment 3 of the invention;

FIG. 7 is a schematic flow of a locating method in the embodiment 4 of the invention;

FIG. 8 illustrates the structure of a MME in the embodiment 5 of the invention;

FIG. 9 illustrates the structure of a MME in the embodiment 6 of the invention;

FIG. 10 illustrates the structure of a locating system in the embodiment 7 of the invention.

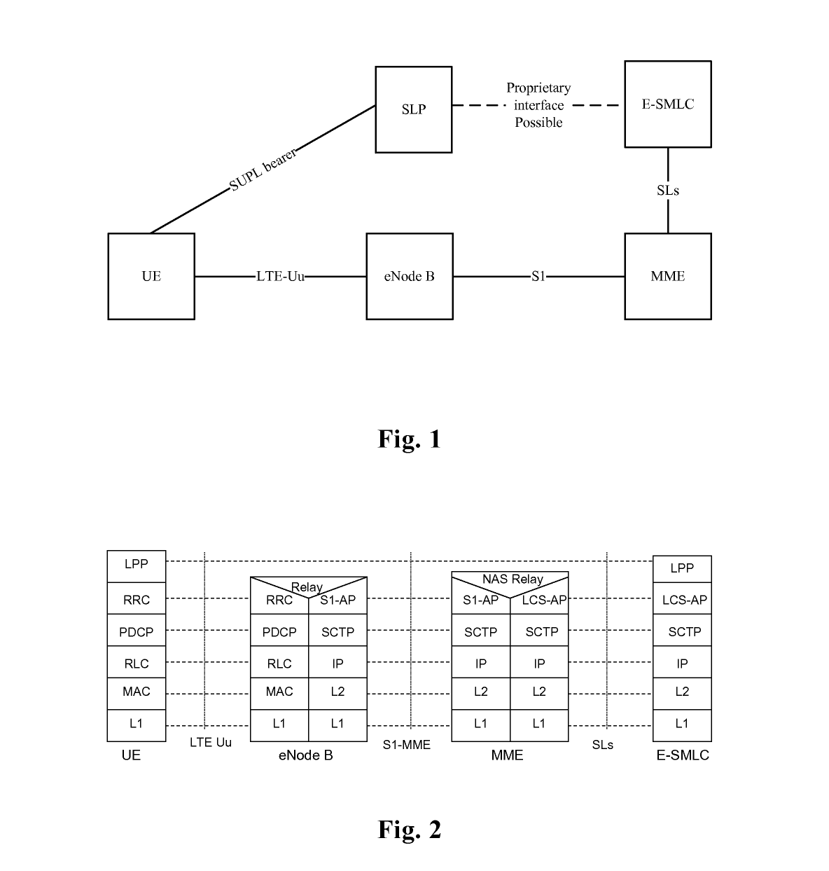

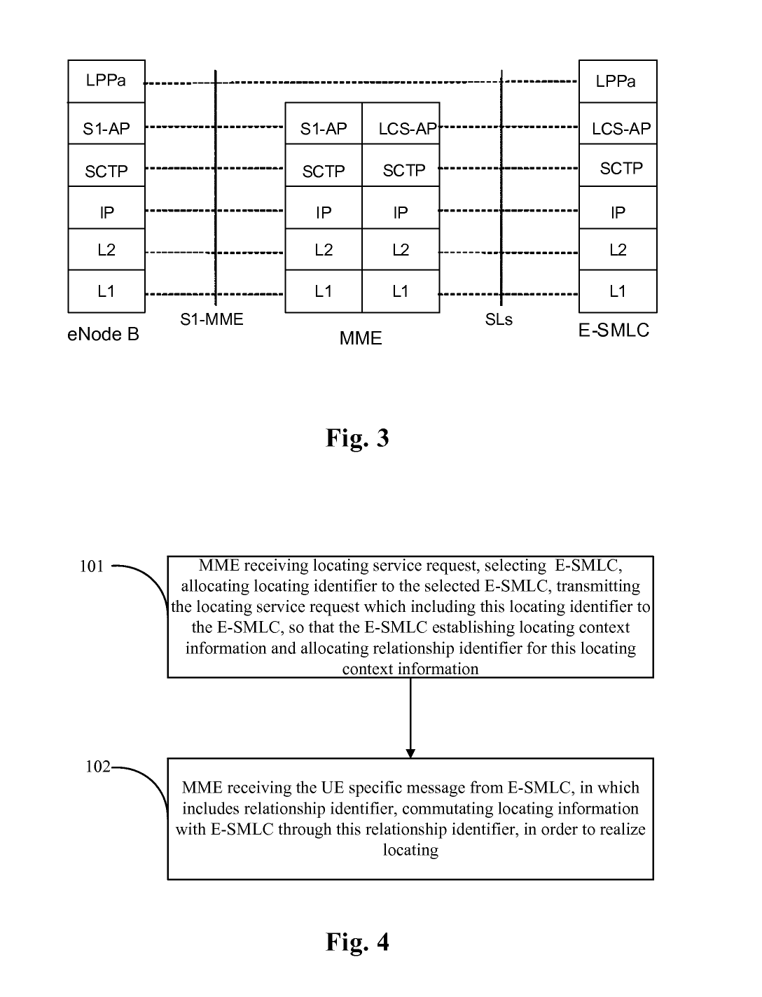

### MODE OF CARRYING OUT THE INVENTION

In the technical proposal provided by the embodiments of the invention, after received locating service request, MME selecting E-SMLC, allocating locating identifier to the selected E-SMLC, transmitting the locating service request which including this locating identifier to the E-SMLC, so that the E-SMLC establishing locating context information and allocating relationship identifier for this locating context information. MME receiving the UE specific message from E-SMLC, in which includes relationship identifier, commutating locating information with E-SMLC through this relationship identifier, in order to realize locating.

Blow the technical proposal of the invention would be described clearly and completely with the figures of the invention, obviously, the embodiments in the following description are only some embodiments of the invention, which are not all the embodiments. According to the embodiments of the invention, all the other embodiments which are obtained by the technical personnel in this field without paying creative labor, are in the protection range of the invention.

As is shown in FIG. 4, a locating method in the embodiment 1 of the invention, comprising following steps:

Step 101, MME receiving locating service request, selecting E-SMLC, allocating locating identifier to the selected E-SMLC, transmitting the locating service request which including this locating identifier to the E-SMLC, so that the E-SMLC establishing locating context information and allocating relationship identifier for this locating context information.

Therein, the locating service request received by MME could be from client, and the network element from core network as well, such as GMLC. The locating identifier which allocated from MME to E-SMLC includes user identifier and session identifier. The user identifier is for distinguishing different users, it could be temporary identifier of UE, as well as perpetual identifier, such as S-TMSI (SAE Temporary Mobile Subscriber Identifier) or IMSI (International Mobile Subscriber Identity); the session identifier is for distinguishing different locating needs for the same user. E-SMLC receiving the locating service request that includes locating identifier, obtaining the locating identifier, and using the locating identifier during subsequent interactive process with MME.

Step 102, MME receiving the UE specific message from E-SMLC, in which includes relationship identifier, commutating locating information with E-SMLC through this relationship identifier, in order to realize locating.

Specifically, after E-SMLC allocated relationship identifier for locating context information, the relationship identifier is carried in the UE specific message that is first transmitted to MME. MME obtaining the relationship identifier, and using the locating identifier during subsequent interactive process with E-SMLC. The identifier could be temporary identifier of UE, as well as perpetual identifier, such as S-TMSI or IMSI.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

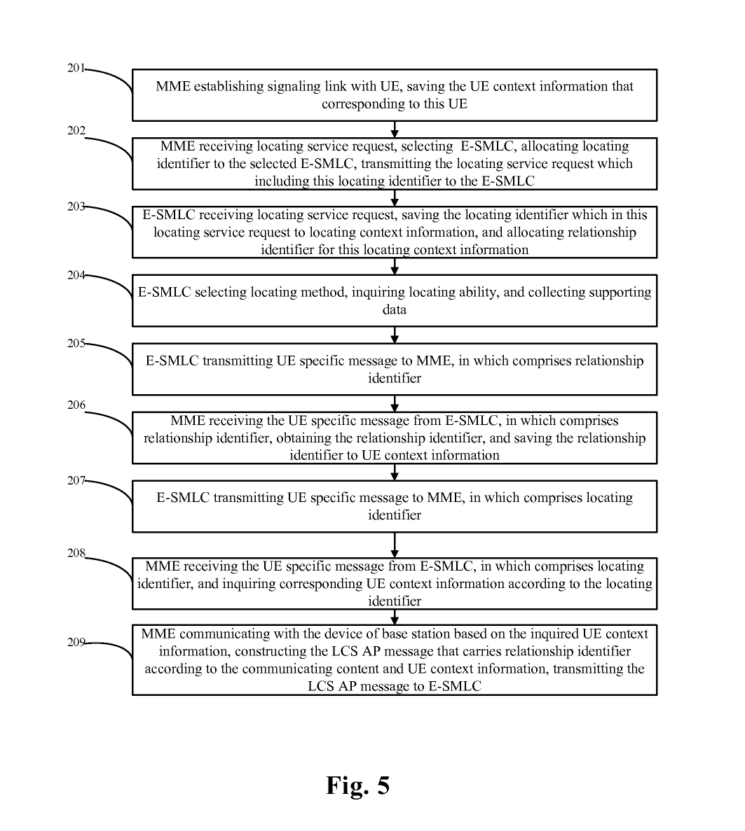

As is shown in FIG. 5, a schematic flow of a locating method in the embodiment 2 of the invention, comprising following steps:

Step 201, MME establishing signaling link with UE, saving the UE context information that corresponding to this UE.

Specifically, before or after receiving each locating service request, MME establishing signaling link with UE, saving the context information corresponding to this UE. The context information includes eNodeB UE S1AP ID and MME UE S1AP ID, and the identifier of the cell which initially establishing link, service eNodeB ID and UE temporary identifier S-TMSI and so on.

Step 202, MME receiving locating service request, selecting E-SMLC, allocating locating identifier to the selected E-SMLC, transmitting the locating service request which including this locating identifier to the E-SMLC.

Specifically, the locating identifier allocated by MME is used for establishing relationship with context information of UE, the locating identifier includes user identifier and session identifier, therein the user identifier could be MME LCSAP ID or MME UE LCSAP ID, and the session identifier could be session ID. MME also could save selected E-SMLC information, each specific locating message issued by E-SMLC will carry the locating identifier allocated by MME.

Besides, MME could establish context relationship through the temporary identifier or perpetual identifier of UE, distinguishing different users through carried S-TMSI or IMSI, distinguishing multiple locating service for the same user through carried session ID.

Step 203, E-SMLC receiving locating service request, saving the locating identifier which in this locating service request to locating context information, and allocating relationship identifier for this locating context information.

Specifically, after received the locating needs from MME, E-SMLC saving locating identifier and establishing locating context accordingly, allocating relationship identifier based on each context, the relationship identifier could be ESMLC LCS AP ID.

Step 204, E-SMLC selecting locating method, inquiring locating ability, and collecting supporting data.

Therein, during E-SMLC determining the locating process that relates to user, including the selection of locating method, the inquiring of locating ability and the collection of supporting data, the LPP portal or LPPa portal could be applied.

Step 205, E-SMLC transmitting UE specific message to MME, in which comprises relationship identifier.

Step 206, MME receiving the UE specific message from E-SMLC, in which comprises relationship identifier, obtaining the relationship identifier, and saving the relationship identifier to UE context information.

Therein, LCS AP could define two different processes to support the content of LPP and LPPa or define one process, and distinguishing different portal stack by adding identifier. After saving the relationship identifier to UE context information, MME distinguishing whether the content of LPPa is included based on the different processes of LCS AP or portal identifier.

Step 207, E-SMLC transmitting UE specific message to MME, in which comprises locating identifier.

Step 208, MME receiving the UE specific message from E-SMLC, in which comprises locating identifier, and inquiring corresponding UE context information according to the locating identifier.

Specifically, all the UE specific messages transmitted from E-SMLC to MME need to carry the locating identifier, which saved in locating context. In addition, E-SMLC carries allocated relationship identifier in the UE specific message, which is first returned to MME, the ESMLC LCS AP ID that used by MME on uplink. If E-SMLC establishing context relationship through IMSI, the UE specific message only carries IMSI, in order to distinguish different users.

Step 209, MME communicating with the device of base station based on the inquired UE context information, constructing the LCS AP message that carries relationship identifier according to the communicating content and UE context information, transmitting the LCS AP message to E-SMLC.

It should be noted that the order of each step in the embodiments of the invention could be adjusted according to practical necessity.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

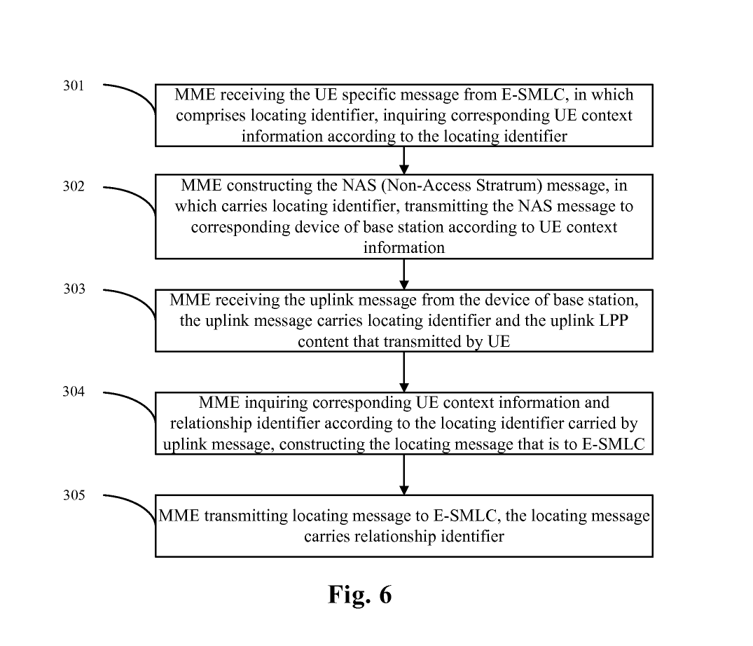

As is shown in FIG. 6, a schematic flow of a locating method in the embodiment 3 of the invention, which is corresponding to LPP process, comprising following steps:

Step 301, MME receiving the UE specific message from E-SMLC, in which comprises locating identifier, inquiring corresponding UE context information according to the locating identifier.

Step 302, MME constructing the NAS (Non-Access Stratrum) message, in which carries locating identifier, transmitting the NAS message to corresponding device of base station according to UE context information.

Specifically, MME constructing NAS PDU (Packet Data Unit), and carrying the NAS PDU in the DOWNLINK NAS TRANSPORT message of S1 port. In order to distinguish different locating service for the same user, MME LCSAP ID or session ID information also should be also carried in NAS message at the same time.

Step 303, MME receiving the uplink message from the device of base station, the uplink message carries locating identifier and the uplink LPP content that transmitted by UE.

Specifically, if UE needs to transmit uplink LPP content, the base station will use the UPLINK NAS TRANSPORT message of S1 port to carry the NAS PDU which includes uplink LPP content, and MME LCSAP ID or session ID information.

Step 304, MME inquiring corresponding UE context information and relationship identifier according to the locating identifier carried by uplink message, constructing the locating message that is to E-SMLC.

Specifically, after being received UPLINK NAS TRANSPORT message, MME determining the corresponding UE context based on the MME UE S1AP ID identifier, then making the corresponding locating service clear according to MME LCSAP ID or session ID information, constructing the locating message that is to E-SMLC, ESMLC LCS AP ID could be included in the locating message, so E-SMLC could identify different locating service. The above UPLINK NAS TRANSPORT message could include IMSI in order to distinguish different users, carrying session ID to distinguishing multiple locating service for the same user.

Step 305, MME transmitting locating message to E-SMLC, the locating message carries relationship identifier.

It should be noted that the order of each step in the embodiments of the invention could be adjusted according to practical necessity.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

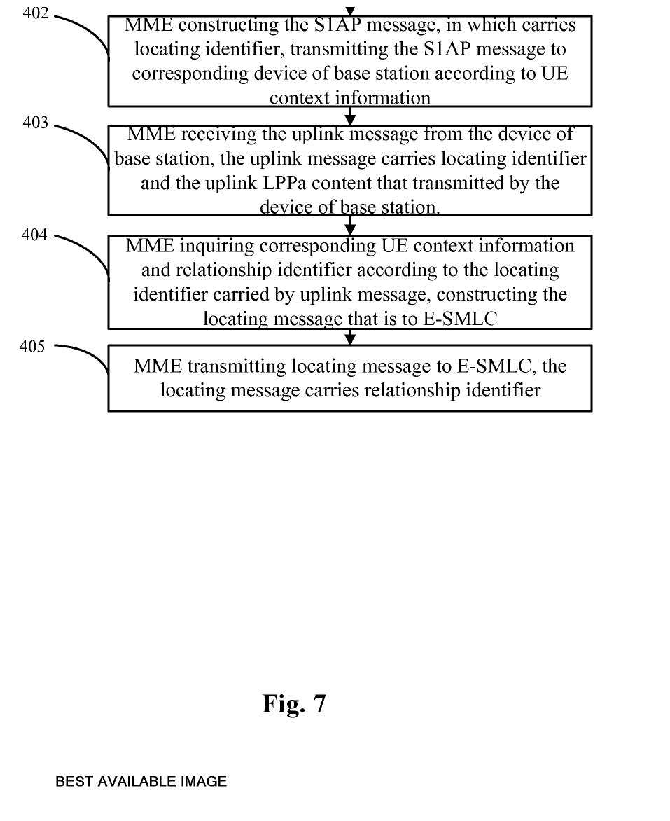

As is shown in FIG. 7, a schematic flow of a locating method in the embodiment 4 of the invention, which is corresponding to LPPa process, comprising following steps:

Step 401, MME receiving the UE specific message from E-SMLC, in which comprises locating identifier, inquiring corresponding UE context information according to the locating identifier.

Step 402, MME constructing the S11AP message, in which carries locating identifier, transmitting the S1AP message to corresponding device of base station according to UE context information.

Specifically, MME constructing corresponding S1AP message, the S1AP message includes eNB UE S1AP ID and MME UE S1AP ID. In order to distinguish different locating service for the same user, MME LCSAP ID or session ID message is needed to be carried in message as well.

Step 403, MME receiving the uplink message from the device of base station, the uplink message carries locating identifier and the uplink LPPa content that transmitted by the device of base station.

Specifically, after being received SlAP message that includes locating needs, the device of base station performing locating measurement according to the locating needs, and carrying measurement result and locating identifier through the LPPa PDU of uplink message during S1AP response process.

Step 404, MME inquiring corresponding UE context information and relationship identifier according to the locating identifier carried by uplink message, constructing the locating message that is to E-SMLC.

After being received uplink message, MME determining the corresponding UE context based on the MME UE S1AP ID identifier, making the corresponding locating service clear according to MME LCSAP ID or session ID information, obtaining the corresponding ESMLC LCS AP ID based on UE context, and determining the corresponding E-SMLC, constructing the locating message that is to the E-SMLC, ESMLC LCS AP ID is included in the locating message, so E-SMLC could identify different locating service. The above uplink message could include IMSI in order to distinguish different users, carrying session ID to distinguishing multiple locating service for the same user.

Step 405, MME transmitting locating message to E-SMLC, the locating message carries relationship identifier.

Specifically, after being received the locating message that carries ESMLC LCS AP ID, E-SMLC determining the corresponding locating context based on ESMLC LCS AP ID, performing locating estimating, and transmitting the locating results to MME, meanwhile, deleting the corresponding locating context. MME will also delete the relationship between locating context and UE context at the same time.

It should be noted that the order of each step in the embodiments of the invention could be adjusted according to practical necessity.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

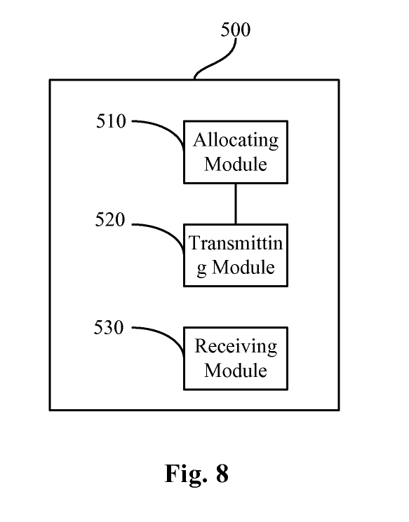

As is shown in FIG. 8, the structure diagram of a MME in the embodiment 5 of the invention, the MME 500 comprising:

Allocating Module 510 for receiving locating service request, selecting E-SMLC, and transmitting locating identifier to the said selected E-SMLC.

Transmitting Module 520 for transmitting the locating service request which includes the locating identifier allocated by Allocating Module 510 to the said E-SMLC, so the said E-SMLC establishing locating context information according to the said locating identifier and allocating relationship identifier for the said locating context information.

Receiving Module 530 for receiving user equipment (UE) specific message that includes relationship identifier from the said E-SMLC, communicating locating information with the said E-SMLC by using the said relationship identifier.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

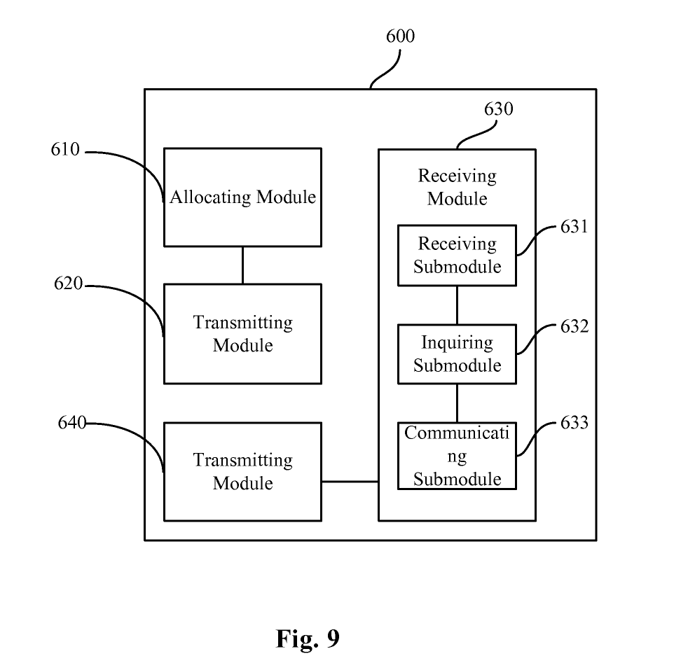

As is shown in FIG. 9, the structure diagram of a MME in the embodiment 6 of the invention, the MME 600 comprising:

Allocating Module 610 for receiving locating service request, selecting E-SMLC, and transmitting locating identifier to the said selected E-SMLC.

Transmitting Module 620 for transmitting the locating service request which includes the locating identifier allocated by Allocating Module 610 to the said E-SMLC, so the said E-SMLC establishing locating context information according to the said locating identifier and allocating relationship identifier for the said locating context information.

Receiving Module 630 for receiving user equipment (UE) specific message that includes relationship identifier from the said E-SMLC, communicating locating information with the said E-SMLC by using the said relationship identifier.

Shortage Module 640 for establishing signaling link with UE, saving the UE context information that corresponding to the said UE.

The Shortage Module 640 also for obtaining the relationship identifier carried by the UE specific messages, which are received by the Receiving Module 630, and saving the said relationship identifier to the said UE context information.

The Receiving Module 630 above specifically comprising:

Receiving Submodule 631 for receiving the UE specific message that includes relationship identifier and locating identifier from the said E-SMLC.

Inquiring Submodule 632 for inquiring corresponding UE context information according to the locating identifier carried by UE specific message, which is received by the said Receiving Submodule 631.

Communicating Submodule 633 for communicating with the device of base station based on the UE context information that inquired by the said Inquiring Submodule 632, and constructing the LCA AP that carries relationship identifier according to the communicating content and the said UE context information, transmitting the said LCS AP message to the said E-SMLC.

The Communicating Submodule 633 above specifically for constructing the Non-Access Stratrum (NAS) message, in which carries locating identifier, transmitting the said NAS message to the corresponding device of base station according to the said UE context information; receiving the uplink message from the said device of base station, the said uplink message carries the said locating identifier and the uplink LPP content that transmitted by UE, constructing the LCS AP message that carries relationship identifier according to the said uplink LPP content and the said UE context information, transmitting the said LCS AP message to the said E-SMLC; or,

Constructing the S1AP message that carries locating identifier, transmitting the said S1AP message to the corresponding device of base station according to the said UE context information; receiving the uplink message from the said device of base station, the said uplink message carries the said locating identifier and the uplink LPPa content that transmitted by the said device of base station, constructing the LCS AP message that carries relationship identifier according to the said uplink LPPa content and the said UE context information, transmitting the said LCS AP message to the said E-SMLC.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

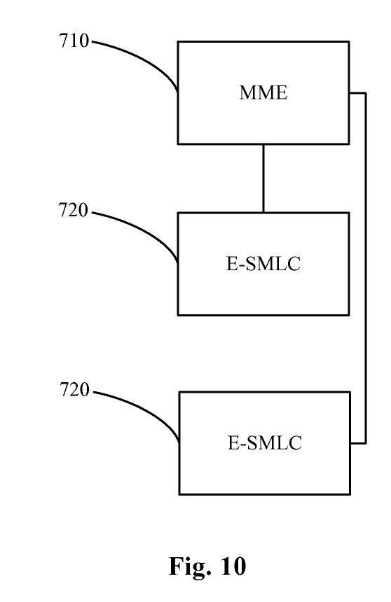

As is shown in FIG. 10, the structure diagram of a locating system in the embodiment 7 of the invention, comprising:

MME 710 for receiving locating service request, selecting E-SMLC 720, and allocating locating identifier for the said selected E-SMLC 720, transmitting the locating service request that includes the said locating identifier to the said E-SMLC 720, receiving the UE specific message that includes relationship identifier from the said E-SMLC 720, communicating locating information with the said E-SMLC 720 by using the said relationship identifier.

E-SMLC 720 for receiving the locating service request from MME 710, saving the locating identifier which in the said locating service request to the said locating context information, and allocating relationship identifier for the said locating context information , transmitting the UE specific messages that include the said locating identifier and/or the said relationship identifier to the said MME 710.

The advantages of the technical proposal that in the embodiments of the invention is as follows: in the processing of locating service, locating identifier and relationship identifier are allocated by MME and E-SMLC separately, and the locating identifier and the relationship identifier are carried during communicating locating information, the correct delivery of the locating information could be ensured, which solves the problem on addressing in present locating scheme, and further improves the accuracy on locating technology.

Through the description of the embodiments above, the technical personnel in this field can understand clearly that the present invention can be implemented by hardware or software and necessary current hardware platform. Based on this understanding, the technical program of the present invention can be embodied by a form of software products which can be stored in a nonvolatile storage medium (such as CD-ROM, U disk, mobile hard disk, etc.), including a number of instructions for making a computer device (such as personal computers, servers, or network equipments, etc.) implement the methods described in the embodiments of the present invention.

The descriptions above are just preferred implement ways of the invention, it should be noted that the improvements and the embellishments within the scope of the tenets of the invention shall be within the protection range of the invention to the technical personnel in this field.

The technical personnel in this field can be understood that the illustration is only schematic drawings of a preferred embodiment, and the module or process is not necessary for the implementation of the present invention.

The technical personnel in this field can be understood that the modules can be distributed in device of the embodiments according to the description of the embodiments above, and also can be varied in one or multiply device of the embodiments. The modules of the embodiments can be combined into a module, and also can be further split into several sub-modules.

The number of the embodiments is only to describe, it does not represent the pros and cons of the embodiments.

The descriptions above are just preferred implement ways of the present invention. It should be pointed that, for general technical personnel in this field, some improvement and decorating can be done, which should be as the protection scope of the present invention.

1. A locating method, wherein, comprising the following steps:
Mobility Management Entity (MME) receiving locating service request, selecting Enhanced Serving Mobile Location Center (E-SMLC), transmitting the locating service request which includes locating identifier to the selected E-SMLC;
The said MME receiving the user equipment (UE) specific message that includes locating identifier, which is transmitted from the said E-SMLC, communicating locating information with the said E-SMLC by using the said locating identifier.

2. The method according to claim 1, wherein, after the said MME transmitting the locating service request which includes locating identifier to the selected E-SMLC, further comprising:
The said E-SMLC saving the locating identifier which in the said locating service request to the said locating context information, and allocating relationship identifier for the said locating context information;
The said E-SMLC selecting locating method, inquiring locating ability, and collecting supporting data;
The said MME receiving the user equipment (UE) specific message that includes locating identifier, which is transmitted from the said E-SMLC, comprising:
The said E-SMLC transmitting the UE specific message that includes the said locating identifier and the said relationship identifier to the said MME.

3. The method according to claim 2, wherein, further comprising:
The said MME establishing signaling link with UE, saving the UE context information that corresponding to the said UE.

4. The method according to claim 3, wherein, after the said MME receiving the UE specific message that includes locating identifier, which is transmitted from the said E-SMLC, further comprising:
The said MME obtaining the said relationship identifier, saving the said relationship identifier to the said UE context information.

5. The method according to claim 3, wherein, the said MME communicating locating information with the said E-SMLC by using the said locating identifier, specifically comprising:
The said MME receiving the UE specific message that includes locating identifier, which is transmitted from the said E-SMLC, inquiring corresponding UE context information according to the said locating identifier.
The said MME communicating with the device of base station based on the said inquired UE context information, constructing the Location Services Application Protocol (LCS AP) message that carries relationship identifier according to the communicating content and the said UE context information, transmitting the said LCS AP message to the said E-SMLC.

6. The method according to claim 5, wherein, the said MME communicating with the device of base station based on the said inquired UE context information, specifically comprising:
The said MME constructing the Non-Access Stratrum (NAS) message, in which carries locating identifier, transmitting the said NAS message to the corresponding device of base station according to the said UE context information; receiving the uplink message from the said device of base station, the said uplink message carries the said locating identifier and the uplink LPP content that transmitted by UE; or,
The said MME constructing the MAP message, in which carries locating identifier, transmitting the said MAP message to the corresponding device of base station according to the said UE context information; receiving the uplink message from the said device of base station, the said uplink message carries the said locating identifier and the uplink LPPa content that transmitted by the said device of base station.

7. The method according to claim 1, wherein, the said locating identifier including user identifier and session identifier, the said user identifier is the temporary identifier of UE or the perpetual identifier of UE.

8. The method according to claim 2, wherein, the said relationship identifier is the temporary identifier of UE or the perpetual identifier of UE.

9. A MME, wherein, comprising:
Allocating Module for receiving locating service request, selecting E-SMLC, and allocating locating identifier for the said selected E-SMLC.
Transmitting Module for transmitting the locating service request which includes the locating identifier allocated by the said Allocating Module to the said E-SMLC, so the said E-SMLC establishing locating context information according to the said locating identifier and allocating relationship identifier for the said locating context information.
Receiving Module for receiving user equipment (UE) specific message that includes relationship identifier from the said E-SMLC, communicating locating information with the said E-SMLC by using the said relationship identifier.

10. The MME according to claim 9, wherein, further comprising:
Shortage Module for establishing signaling link with UE, saving the UE context information that corresponding to the said UE.

11. The MME according to claim 10, wherein,
The said Shortage Module also for obtaining the relationship identifier carried by the UE specific messages, which are received by the said Receiving Module, saving the said relationship identifier to the said UE context information.

12. The MME according to claim 10, wherein, the said Receiving Module, specifically comprising:
Receiving Submodule for receiving the UE specific message that includes relationship identifier and locating identifier from the said E-SMLC;
Inquiring Submodule for inquiring corresponding UE context information according to the locating identifier carried by UE specific message, which is received by the said Receiving Submodule;
Communicating Submodule for communicating with the device of base station based on the UE context information that inquired by the said Inquiring Submodule, and constructing the LCA AP that carries relationship identifier according to the communicating content and the said UE context information, transmitting the said LCS AP message to the said E-SMLC.

13. The MME according to claim 12, wherein,
The said Communicating Submodule specifically for constructing the Non-Access Stratrum (NAS) message, in which carries locating identifier, transmitting the said NAS message to the corresponding device of base station according to the said UE context information; receiving the uplink message from the said device of base station, the said uplink message carries the said locating identifier and the uplink LPP content that transmitted by UE, constructing the LCS AP message that carries relationship identifier according to the said uplink LPP content and the said UE context information, transmitting the said LCS AP message to the said E-SMLC; or,
Constructing the S1AP message that carries locating identifier, transmitting the said S1AP message to the corresponding device of base station according to the said UE context information; receiving the uplink message from the said device of base station, the said uplink message carries the said locating identifier and the uplink LPPa content that transmitted by the said device of base station, constructing the LCS AP message that carries relationship identifier according to the said uplink LPPa content and the said UE context information, transmitting the said LCS AP message to the said E-SMLC.

14. A MME, wherein, comprising:
Allocating Module for receiving locating service request, selecting E-SMLC;
Transmitting Module for transmitting the locating service request which includes locating identifier to the E-SMLC that selected by the said Allocating Module;
Receiving Module for receiving UE specific message that includes relationship identifier, which is transmitted from the said E-SMLC, communicating locating information with the said E-SMLC by using the said relationship identifier.

15. The MME according to claim 14, wherein, further comprising:
Shortage Module for establishing signaling link with UE, saving the UE context information that corresponding to the said UE.

16. The MME according to claim 15, wherein, the said Receiving Module, specifically comprising:
Receiving Submodule for receiving the UE specific message that includes relationship identifier and locating identifier from the said E-SMLC;
Inquiring Submodule for inquiring corresponding UE context information according to the locating identifier carried by UE specific message, which is received by the said Receiving Submodule;
Communicating Submodule for communicating with the device of base station based on the UE context information that inquired by the said Inquiring Submodule, and constructing the LCA AP that carries relationship identifier according to the communicating content and the said UE context information, transmitting the said LCS AP message to the said E-SMLC.

17. A locating system, wherein, comprising:
MME for receiving locating service request, selecting E-SMLC, and allocating locating identifier for the said selected E-SMLC, transmitting the locating service request that includes the said locating identifier to the said E-SMLC, receiving the UE specific message that includes relationship identifier from the said E-SMLC, communicating locating information with the said E-SMLC by using the said relationship identifier;
E-SMLC for receiving the locating service request from the said MME, saving the locating identifier which in the said locating service request to the said locating context information, and allocating relationship identifier for the said locating context information, transmitting the UE specific messages that include the said locating identifier and/or the said relationship identifier to the said MME.

18. A locating system, wherein, comprising:
MME for receiving locating service request, selecting E-SMLC, transmitting the locating service request that includes locating identifier to the said selected E-SMLC, receiving the UE specific message that includes relationship identifier from the said E-SMLC, communicating locating information with the said E-SMLC by using the said relationship identifier;
E-SMLC for receiving the locating service request from the said MME, saving the locating identifier which in the said locating service request to locating context information, transmitting the UE specific messages that include the said locating identifier to the said MME.
